(19) United States
(12) Patent Application Publication
(10) Pub. No.: US 2016/0312153 A1
(43) Pub. Date: Oct. 27, 2016

(54) MODIFIED POLYSACCHARIDE FOR USE IN LAUNDRY DETERGENT AND FOR USE AS ANTI-GREYING AGENT

(71) Applicant: BASF SE, Ludwigshafen (DE)

(72) Inventors: Stephan HÜFFER, Ludwigshafen (DE); Alejandra GARCIA MARCOS, Ludwigshafen (DE); Jürgen DETERING, Limburgerhof (DE)

(73) Assignee: BASF SE, Ludwigshafen (DE)

(21) Appl. No.: 15/104,290

(22) PCT Filed: Dec. 10, 2014
(86) PCT No.: PCT/EP2014/077221

§ 371 Date: Jun. 14, 2016

(30) Foreign Application Priority Data
Dec. 16, 2013 (EP) 13197458.6

(51) Int. Cl. C11D 3/00; C11D 11/00; C11D 3/42; C08B 37/00; C11D 3/22

(52) U.S. Cl. CPC C11D 3/0036; C08B 37/0057; C08B 37/0087; C11D 3/228; C11D 3/222; C11D 3/42; C11D 11/0017

(57) ABSTRACT

The present invention relates to a modified polysaccharide obtainable by a process comprising the step of treating a polysaccharide with gaseous or liquid SO₂, a laundry detergent composition comprising said modified polysaccharide, the use of said modified polysaccharide to increase whiteness of a washed fabric, the use of said modified polysaccharide as anti-greying agent in aqueous laundry processes, the use of said modified polysaccharide as a rheology modifier for homecare applications and the use of said modified polysaccharide in the manufacture of a liquid laundry composition. Further aspects of the invention are a method for preparing a laundry detergent composition comprising said modified polysaccharide.

The present invention relates to a modified polysaccharide obtainable by a process comprising the step of treating a polysaccharide with gaseous or liquid SO₂, a laundry detergent composition comprising said modified polysaccharide, the use of said modified polysaccharide to increase whiteness of a washed fabric, the use of said modified polysaccharide as anti-greying agent in aqueous laundry processes, the use of said modified polysaccharide as a rheology modifier for homecare applications and the use of said modified polysaccharide in the manufacture of a liquid laundry composition. Further aspects of the invention are a method for preparing a laundry detergent composition comprising said modified polysaccharide.

During the washing process of laundry, redeposition of soil may occur which leads to a general greying of textiles. In order to reduce redeposition of soil, native or modified polysaccharides such as carboxymethylpolysaccharide (CMC) can be added to laundry detergent compositions (see e.g. EP 2 135 933 A1). The use of native or modified polysaccharides available in the art is however limited since most of them typically have a high viscosity in water and, thus, form a gel when formulated in liquid laundry detergent compositions. Therefore, most of them can only be used in powder detergent compositions. Although many different types of polysaccharides are known in the art, only a limited number is suitable for the use in liquid laundry detergent compositions such as e.g. modified polysaccharides with weight average molecular weight of 250,000 or less (see e.g. WO 00/40684).

The objective of the present invention is therefore to provide anti-greying agents which can be used in liquid laundry detergent compositions.

Surprisingly, it has now been found that the mentioned objective can be met to a great extent by the provision of a modified polysaccharide obtainable by a process comprising the step of treating a polysaccharide with gaseous or liquid SO₂. Such a modified polysaccharide has excellent anti-greying properties and can successfully be formulated into liquid laundry detergent compositions.

One aspect of the invention is a modified polysaccharide obtainable by a process comprising the step of treating a polysaccharide with gaseous or liquid SO₂.

In a preferred embodiment, the polysaccharide is xyloglucan, mannan, xylan, starch or mixtures thereof.

In a more preferred embodiment, the polysaccharide is xyloglucan.

Xyloglucans are widespread in nature. They belong to a group of polysaccharides typically referred to as hemicelluloses and can be found in primary cell walls of different plants, such as for example plants belonging to the class dicotyledons and plants belonging to the sub-class non-graminacious monocotyledons. In accordance with the present invention, any xyloglucan can be used for the preparation of modified xyloglucan.

A few among these plants (all of which are dicotyledons) use xyloglucan also as a carbohydrate reserve instead of the most common carbohydrate reserve starch. Seeds of these plants have thick cell walls containing vast quantities of xyloglucan. Examples for such plants are flowering plants of the genus Nasturtium, such as Nasturtium africanum, Nasturtium fiendanum, Nasturtium gambe/ii, Nasturtium microphyllum, Onerow yellowcress and Nasturtium offickiale flowering plants of the genus Impatiens, such as Impatiens balfouni; Impatiens baisainina, Impatiens capensis, Impatiens edgeworthii, Impatiens g/andullfera, Impatiens hians, Impatiens mananae, Impatiens rilamniamensis Impatiens nolil-tangere, Impatiens Awitiora Impatiens platypetala, Impatiens repens, flowering plants of the genus Annonas, such as Annona ainambayensis; Annona acuminata. Annona ambotay, Annona asplundiana, Annona atabapensis, Annona bullata, Annona bifiora Annona bkalot; Annona brasbillensis Annona cacans, Annona oalophylla, Annona campestris, Annona chenhlok Annona chrysophylla, Annona pubescens, Annona tripetala, Annona conka, Annona coriacea, Annona connfolla, Annona crassifibra, Annona cristalensis, Annona crotorniblia, Annona deceptrix, Annona demihuta, Annona Annona diverstfolia, Annona dolabripetala Annona clolichophylla Annona echinata, Annona ecuadorensis, Annona ekmatm; Annona eArellens, Annona glabra Annona palustris, Annona glatkohylia, Annona haematantha Annona hayestic Annona hypoglauca Annona hystrkotdes Annona jahnli; Annona latilakenSIS, Annona longlfiora, Annona lutescens, Annona macrocalyx, Annona malmeana, Annona trianattisis, Annona microcarpa, Annona montana, Annona marcgravk Annona monticola, Annona muricata, Annona macmcwriv Annona nittda, Annona nutans, Annona ollgoarpa Annona, Annona paraguayensis, Annona phaeoclados, Annona praelennissa, Annona purpurea, Annona pygmaea, Annona retkulata, Annona saizmannk, Annona scleroderma, Annona senegaiensis, Annona SetiCeas Annona spinescens, Annona spraguet, Annona squamosa, Annona testudinea, Annona tomentosa, Annona trunolfiora, and trees of the genus Tamarindus such as Tamarindus indica.

More details about xyloglucan structures and methods of their structure determination can be found in S. F. Fry. J. Expt. Botany 1989, 40, 1-11; A. Mishra et al., J. Mater. Chem. 2009, 19, 8528-8536; W. York et al., Carbohydr. Res. 1990, 200, 9-31; Hoffman et al., Carbohydr. Res. 2005, 340, 1826-1840; W. York et al., Carbohydr. Res, 1996, 25 285, 98-128; and the literature cited therein.

In a preferred embodiment, the modified polysaccharide in accordance with the present invention is tamarind xyloglucan.

Tamarind xyloguclan is commercially available. Some suppliers for tamarind flakes and powders are Vishnu gum and chemicals (India), TCI Germany GmbH (Germany), Altrafine Gums (India), Balasanka (India), Ramachandra Pulverisers & Industries (India), The Andhra starch (India), MYSORE (India), Dainippon Sumitomo Pharma (Japan), Vishnu Engeneering Works (India), Shree Vinayak Corporation (India), Megazyme (Ireland).

In another preferred embodiment, the polysaccharide is a mannan, preferably a glucomannan. More details about mannan structures and methods of their structure determination can be found in McGraw-Hill: Hemicellulose, Encyclopedia of Science and Technology, 5th edition, 2005; in Moreira L R, Filho E X., Appl Microbiol Biotechnol. 2008 May; 79(2):165-78, and Kaname Katsuraya, Kohsaku Okuyamab, Kenichi Hatanakab, Ryuichi Oshimab, Takaya Satoc, and Kei Matsuzakic (2003), “Constitution of konjac glucomannan: chemical analysis and 13C NMR spectroscopy”, in Carbohydrate Polymers 53 (2): 183-189 and the literature cited therein.

In another preferred embodiment, the polysaccharide is a xylan, preferably a homoxylan or an arabinoxylan. More details about xylan structures and methods of their structure determination can be found in F. L. Motta, C. C. P. Andrade and M. H. A. Santana, A Review of Xylanase Production by the Fermentation of Xylan: Classification, Characterization and Applications, Sustainable Degradation of Lignocellulosic Biomass—Techniques, Applications and Commercialization, May 15, 2013; Pellerin P. Gosselin M, Lepoutre J P. Samain E. Debeire P. Enzymatic production of oligosaccharides from corncob xylan, Enzyme and Microbial Technology (1991) 13:617-621 and Verma D, Satyanarayana T. Molecular approaches for ameliorating microbial xylanases, Bioresource Technology (2012) 17: 360-367.

The modified polysaccharide of the present invention is obtainable by a process comprising the step of treating a polysaccharide with gaseous or liquid SO₂. Thus, the polysaccharide may be treated with gaseous SO₂, for example by sparging SO₂ through an aqueous solution comprising the polysaccharide. Alternatively, an aqueous solution comprising the polysaccharide may be mixed with liquid SO₂ which is obtainable, for example, by dissolving gaseous SO₂ in water.

The treatment of the polysaccharide with gaseous or liquid SO₂ can be carried out in a stirred vessel or autoclave.

The polysaccharide to be treated with gaseous or liquid SO₂ can be in the form of powder or in the form of an aqueous solution. Preferably, the polysaccharide in powder form is added to an aqueous SO₂ solution.

In a preferred embodiment, the process is carried out (at atmospheric pressure) with a process-mass ratio of SO₂ to polysaccharide of from 0.1:1 to 5:1, preferably 0.2:1 to 1:1 and more preferably 0.2:1 to 0.5:1. The process-mass ratio of SO₂ to polysaccharide is a ratio by weight. In a pressurized process (1 bar to 10 bar) the mass ratio can be reduced to 0.01:1 to 5:1, preferably 0.01:1 to 1:1 and more preferably 0.02:1 to 0.5:1.

The modified polysaccharide of the present invention preferably shows a viscosity at 25° C. when dissolved at 2% in water of less than 100 mPas. When dissolved at 5% in water, said polysaccharide preferably has a viscosity at 25° C. of 20 to 1500 mPas. When dissolved at 10% in water said polysaccharide preferably has a viscosity at 25° C. of less than 15,000 mPas. When dissolved at 15% in water said polysaccharide preferably has a viscosity at 25° C. of less than 100,000 mPas. The viscosity can be determined with Brookfield according to DIN ISO 2555:2000-01 (LVT spindle, RT).

In another preferred embodiment, the process is carried out at a temperature in the range of from 0 to 150° C., preferably 40 to 150° C., more preferably 70 to 120° C. and even more preferably in the range of from 70 to 95° C.

In another preferred embodiment, the process is carried out at a pressure in the range of from 0 (atm. pressure) to 10 bar, preferably in the range of from 1 to 3 bar, when the process is carried out at a temperature between 95 and 150° C.

In a further preferred embodiment, the process is carried out for 1 minute to 10 hours, preferably for 5 minutes to 8 hours, more preferably for 1 to 6 hours, even more preferably for 30 minutes to 5 hours. In an even more preferred embodiment, the process is carried out for 1 to 90 minutes, more preferably for 5 to 30 minutes.

In a preferred embodiment, the process is carried out at a pressure in the range of from 0.1 to 10 bar, at a temperature between 110 and 150° C. for 1 to 90 minutes, preferably for 5 to 30 minutes.

In another preferred embodiment, the process is carried out at atmospheric pressure, at a temperature between 1 and 95° C., preferably 75-93° C. for 30 minutes to 10 hours, preferably for 1 hour to 8 hours.

In a further preferred embodiment, the process further comprises the step of adjusting the pH in the range of from 3 to 7, preferably in the range of 4 to 6, more preferably in the range of 5 to 6.

Another aspect of the present invention is a laundry detergent composition comprising a modified polysaccharide of the present invention.

In a preferred embodiment, said laundry detergent is liquid or gel-like. Liquid in accordance with the present invention means a viscosity of less than 500 mPas at room temperature and gel-like in accordance with the present invention means viscous but still pourable, i.e. a viscosity of less than 10,000 mPas at room temperature, preferably a viscosity between 500 and 10,000 mPas at room temperature. The viscosity can be determined with Brookfield according to DIN ISO 2555:2000-01 (LVT spindle, RT).

In one embodiment of the present invention, modified polysaccharide of the present invention (A) is a component of a laundry detergent composition that additionally comprises at least one surfactant (B) and at least one builder (C).

The surfactant is preferably selected from anionic, nonionic, cationic, amphoteric and/or zwitterionic surfactant.

Suitable nonionic surfactants are in particular:
alkoxylated C₈-C₂₂-alcohols such as fatty alcohol

alkoxylates, oxo alcohol alkoxylates and Guerbet alcohol alkoxylates: the alkoxylation can be effected with C₂-C₂₀ alkylene oxides, preferably ethylene oxide, propylene oxide and/or butylene oxide. Block copolymers or random copolymers may be present. Per mole of alcohol, they comprise typically from 2 to 50 mol, preferably from 3 to 20 mol of at least one alkylene oxide. The preferred alkylene oxide is ethylene oxide. The alcohols have preferably from 10 to 18 carbon atoms.
alkyl phenol alkoxylates, especially alkylphenol ethoxylates which comprise C₈-C₁₄-alkyl chains and from 5 to 30 mol of alkylene oxide/mole,
alkylpolyglucosides which comprise C₈-C₂₂-alkyl, preferably C₁₀-C₁₈-alkyl chains and generally from 1 to 20, preferably from 1.1 to 5 glucoside units.
N-alkylglucamides, fatty acid amide alkoxylates, fatty acid alkanolamide alkoxylates and block copolymers of ethylene oxide, propylene oxide and/or butylene oxide.

Suitable anionic surfactants are, for example:
sulfates of (fatty) alcohols having from 8 to 22, preferably from 10 to 18 carbon atoms, especially C₉C₁₁-alcohol sulfates, C₁₂C₁₄-alcohol sulfates, C₁₂-C₁₃-alcohol sulfates, lauryl sulfate, cetyl sulfate, myristyl sulfate, palmityl sulfate, stearyl sulfate and tallow fat alcohol sulfate.
sulfated alkoxylated C₈-C₂₂-alcohols (alkyl ether sulfates): compounds of this type are prepared, for example, by first alkoxylating a C₈-C₂₂-alcohol, preferably a C₁₀-C₁₈-alcohol, for example a fatty alcohol, and then sulfating the alkoxylation product. For the alkoxylation, preference is given to using ethylene oxide.
linear C₈-C₂₀ alkylbenzenesulfonates (LAS), preferably linear C₆-C₁₃-alkylbenzenesulfonates and -alkyltoluenesulfonates, alkanesulfonates, especially C₈-C₂₄-alkanesulfonates, preferably C₁₀-C₁₈-alkanesulfonates.
fatty acid ester sulfonates of the formula R¹CH(SO₃M)CO₂R² in which R¹ is C₆-C₂₀-alkyl, preferably C₈-C₁₆-alkyl, and R² is C₁-C₄-alkyl, preferably methyl or ethyl, and M is hydrogen, a water-soluble cation, for example alkali metal cation or ammonium ion.
olefinsulfonates having from 8 to 22, preferably from 12 to 18, carbon atoms, isethionates, especially acyl isethionates and N-acyl taurates,
N-acyl sarcosinates,
sulfosuccinates (mono- or diesters of sulfosuccinic acid) and alkyl succinates,
organic phosphate esters, especially mixtures of mono- and diester phosphates of hydroxylterminated alkoxide condensates and salts thereof. These include polyoxalkylated alkylarylphosphate esters, for example based on alkoxylated C₈-C₂₂-alcohols or alkoxylated phenol derivatives.
soaps such as the sodium and potassium salts of C₈-C₂₄-carboxylic acids.

The anionic surfactants are added to the detergent preferably in the form of salts. Suitable salts are, for example, alkali metal salts such as sodium, potassium and lithium salts, and ammonium salts such as hydroxyethylammonium, di(hydroxyethyl) ammonium and tri(hydroxyethypammonium salts.

Particularly suitable cationic surfactants include:
C₇-C₂₅ alkylamines;
N, N-dimethyl-N—(C₇-C₂₅-hydroxyalkyl)ammonium salts;
mono- and di(C₇-C₂₅-alkyl)dimethylammonium compounds quaternized with alkylating agents;
ester quats, especially quaternary esterified mono-, di- and trialkanolamines which have been esterified with C₈-C₂₂-carboxylic acids;
imidazoline quats.

Suitable amphoteric surfactants are derivatives of aliphatic or heterocyclic, secondary and tertiary amines in which the aliphatic radicals preferably have from 8 to 18 carbon atoms and at least one radical comprises one or more anionic water-soluble groups, for example one or more carboxylate, sulfonate, sulfate, phosphate or phosphonate groups, Examples of suitable amphoteric surfactants are:
3-(alkylamino)propionates, (alkylamino)acetates, 3-(dialkylamino)propionates and (dialkylamino) acetates, where preferably at least one alkyl group comprises from 8 to 18 carbon atoms.
3-[(3-alkylamidopropyl)amino]propionates and [(3-alkylamidopropyl)amino]acetates, where the alkyl group preferably comprises from 8 to 18 carbon atoms.
[(2-amylaminoethyl)(2-hydroxyethyl)amino]acetates where the acyl group preferably comprises from 8 to 18 carbon atoms.
(alkylamino)propanesulfonates where the alkyl group preferably comprises from 8 to 18 carbon atoms.

Suitable zwitterionic surfactants are, for example:
amine oxides, especially alkyldimethylamine oxides and alkyldimethylamine oxides, where the alkyl group preferably comprises from 8 to 18 carbon atoms.
betaines, especially carbobetaines, sulfobetaines and phosphobetaines, such as:

R⁶(R⁷)₂N⁺(CH₂)ₙCOO— with the following preferred definition of the variables:

R⁶: C₈-C₁₈-alkyl; R⁷: C₁-C₃-alkyl; n: from 1 to 5.

R⁶CONH(CH₂)ₘ(R⁷)₂NICH₂)ₙCOO— with the following preferred definition of the variables: R⁶:

C₇-C₁₇-alkyl; R⁷: C₁-C₃-alkyl; n, m: each independently from 1 to 5.

R⁶(R⁷)₂N⁺(CH₂)ₙSO₃— with the following preferred definition of the variables:

R⁶: C₈-C₁₈-alkyl; R⁷: C₁-C₃-alkyl; n: from 1 to 5.
cocoamidopropylbetaine.

Detailed descriptions of amphoteric and zwitterionic surfactants can also be found in EP-A-851 023 and also in Die Tenside [The surfactants], Carl Hanser Verlag, 1993.

Examples of builders (C) are complexing agents, hereinafter also referred to as complexing agents (C), ion exchange compounds, and precipitating agents (C). Examples of builders (C) are citrate, phosphates, silicates, carbonates, phosphonates, amino carboxylates and polycarboxylates.

Examples of complexing agents (C) (“sequestrants”) are selected from complexing agents such as, but not limited to citrate, phosphates, phosphonates, silicates, and ethylene amine derivatives selected from ethylene diamine tetraacetate, diethylene pentamine pentaacetate, methylglycine diacetate, and glutamine diacetate. Complexing agents (C) will be described in more details below.

Examples of precipitating agents (C) are sodium carbonate and potassium carbonate,

In one embodiment of the present invention, the use according to the invention comprises the use of modified polysaccharide of the present invention (A) together with at least one enzyme (D). Useful enzymes are, for example, one or more lipases, hydrolases, amylases, proteases, cellulases, hemicellulases, phospholipases, esterases, pectinases, lactases and peroxidases, and combinations of at least two of the foregoing types of the foregoing.

The use according to the invention can deal with any type of laundry, and with any type of fibers. Fibers can be of natural or synthetic origin, or they can be mixtures of natural of natural and synthetic fibers. Examples of fibers of natural origin are cotton and wool. Examples for fibers of synthetic origin are polyurethane fibers such as Spandex@ or Lycra®, polyester fibers, or polyimide fibers. Fibers may be single fibers or parts of textiles such as knitwear, wovens, or nonwovens.

The use according to the invention can be performed by applying modified polysaccharide of the present invention (A) as a liquid, for example as a solution or gel, as a foam or as solid to fibres. It is preferred to use modified polysaccharide in the present invention (A) in a washing liquor. Before application, it can be stored in a formulation that may be solid or liquid, liquid being preferred.

Preferably, the use according to the invention can be performed for cleaning, for example for desoiling, degreasing, or the like of laundry. The soil or dirt to be removed can be proteins, grease, fat, oil, sebum, non-polar soils like soot and byproducts of incomplete hydrocarbon combustion, particulate stains such as pigments and clays, or mixtures of at least two of the foregoing. Particularly preferred is the use according to the invention for grease removal (degreasing) and clay soil removal/anti redeposition.

It is preferred to use modified polysaccharide of the present invention (A) at a temperature in the range of from 15 to 90° C., preferably in the range of from 20 to 60° C.

The use according to the invention can be performed manually but it is preferred to apply modified polysaccharide of the present invention (A) mechanically, for example in a washing machine.

A further aspect of the present invention are laundry detergent compositions, in the context of the present invention also being referred to as compositions according to the invention. Laundry detergent compositions according to the invention can be liquid, gels, or solid compositions, solid embodiments encompassing, for example, powders and tablets. Liquid laundry detergent compositions may be packaged as unit doses.

A laundry detergent composition according to the present invention comprising a modified polysaccharide of the present invention. In a preferred embodiment, said modified polysaccharide can be present in the amount of from 0.1 to 40% by weight, preferably in an amount of from 0.2 to 30 and more preferably in an amount of from 0.5 to 10% by weight.

In a preferred embodiment, laundry detergent compositions according to the invention comprise
(A) at least one modified polysaccharide of the present invention,
(B) at least one surfactant,
(C) at least one builder, selected from citrate, phosphates, silicates, carbonates, phosphonates, amino carboxylates and polycarboxylates.

Modified polysaccharide of the present invention (A) and surfactants (B) have been defined above.

Laundry detergent compositions according to the invention may comprise at least one builder (C). In the context of the present invention, no distinction will be made between builders and such components elsewhere called “co-builders”. Examples of builders (C) are complexing agents, hereinafter also referred to as complexing agents (C), ion exchange compounds, and precipitating agents (C). Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphatefree”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na₂CO₃.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylenediaminetetramethylenephosphonate (EDTMP), diethylenetriaminepentamethylenphosphonate (DTPMP), and also their higher homologues. They are preferably used in the form of the neutrally reacting sodium salts, e.g. as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate.

The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na₂Si₂O₅, β-Na₂Si₂O₅, and δ-Na₂Si₂O₅.

Laundry detergent compositions according to the invention may contain one or more builder selected from materials not being mentioned above. Examples of builders are α-hydroxypropionic acid and oxidized starch.

In one embodiment of the present invention, builder (C) is selected from polycarboxylates. The term “polycarboxylates” includes non-polymeric polycarboxylates such as succinic acid, C₂-C₁₆-alkyl disuccinates. C₂-C₁₆-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid, polyacrylic acid and polymethacrylic acid their alkali metal salts.

A suitable polymer is in particular polyacrylic acid (or its alkali metal salt), which preferably has an average molecular weight M_{w} in the range of from 1,000 to 40,000 g/mol, more preferably 1,000 to 10,000 g/mol, in particular 1,000 to 8,000 g/mol. Also of suitability are copolymers of acrylic acid with methacrylic acid and copolymers of acrylic acid and/or methacrylic acid with at least one monomer from the group consisting of monoethylenically unsaturated C₄-C₁₀dicarboxylic acids or anhydrides thereof, such as maleic acid, maleic anhydride, fumaric acid, itaconic acid and citraconic acid.

It is also possible to use copolymers of at least one monomer from the group consisting of monoethylenically unsaturated C₃-C₈-monocarboxylic acids and monoethylenically unsaturated C₄-C₁₀-dicarboxylic acids or anhydrides thereof, such as acrylic acid, methacrylic acid, maleic acid, maleic anhydride, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene. C₂₂-α-olefin, a mixture of C₂₀-C₂₄-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. The following monomers serve as example: allyl alcohol and its alkoxylates, isoprenol and its alkoxylates, methoxypolyethylene glycol (meth)acrylate, methoxypolypropylene glycol (meth)acrylate, methoxypolybutylene glycol (meth)acrylate, nnethoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinyiphosphonic acid and its salts.

Moreover, amphoteric polymers can also be used as builders.

Laundry detergent compositions according to the invention can comprise, for example, in the range from in total 0.1 to 70% by weight, preferably 10 to 50% by weight, preferably up to 20% by weight, of builder(s) (C), especially in the case of solid formulations. Liquid formulations according to the invention preferably comprise in the range of from 0.1 to 8% by weight of builder (C).

Laundry detergent compositions according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium.

Examples of useful enzymes (D) are one or more lipases, hydrolases, amylases, proteases, cellulases, hemicellulases, phospholipases, esterases, pectinases, lactases and peroxidases, and combinations of at least two of the foregoing types of the foregoing.

Enzyme (D) can be incorporated at levels sufficient to provide an effective amount for cleaning.

The preferred amount is in the range from 0.001% to 5% of active enzyme by weight in the detergent composition according to the invention. Together with enzymes also enzyme stabilizing systems may be used such as for example calcium ions, boric acid, boronic acids, propylene glycol and short chain carboxylic acids. In the context of the present invention, short chain carboxylic acids are selected from monocarboxylic acids with 1 to 3 carbon atoms per molecule and from dicarboxylic acids with 2 to 6 carbon atoms per molecule. Preferred examples are formic acid, acetic acid, propionic acid, oxalic acid, succinic acid, HOOC(CH₂)₃COOH, adipic acid and mixtures from at least two of the foregoing, as well as the respective sodium and potassium salts.

Laundry detergent compositions according to the invention may comprise one or more bleaching agent (E) (bleaches).

Preferred bleaches (E) are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H₂SO₅ and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Laundry detergent compositions according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Laundry detergent compositions according to the invention can comprise one or more bleach activators, for example tetraacetyl ethylene diamine, tetraacetylmethylenediamine, tetraacetylglycoluril, tetraacetylhexylenediamine, acylated phenolsulfonates such as for example n-nonanoyl- or isononanoyloxybenzene sulfonates, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Laundry detergent compositions according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, laundry detergent compositions according to the invention comprise in total in the range from 0.1 to 1.5% by weight of corrosion inhibitor.

Laundry detergent compositions according to the invention can comprise one or more builders, for example sodium sulfate.

Laundry detergent compositions according to the invention may comprise at least one additional surfactant, selected from non-ionic, anionic, cationic, zwitterionic and/or amphoteric surfactants as defined above.

Further optional ingredients may be but are not limited to viscosity modifiers, cationic surfactants, foam boosting or foam reducing agents, perfumes, dyes, optical brighteners, dye transfer inhibiting agents and preservatives.

Liquid laundry detergent compositions according to the invention may contain water in amounts (based on the total composition) of preferably up to approx. 80 wt % and in particular 40 wt % to 70 wt %, whereby this may, if desired, also be replaced proportionally by a water-soluble solvent component. Nonaqueous solvents that may be used in the liquid laundry detergent compositions originate from the group of monovalent or polyvalent alcohols, alkanolamines or glycol ethers, for example, if they are miscible with water in the concentration range indicated. The solvents are preferably selected from ethanol, n-propanol or isopropanol, the butanols, ethylene glycol, butanediol, glycerol, diethylene glycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl, ethyl or propyl ether, dipropylene glycol monomethyl or ethyl ether, diisopropylene glycol monomethyl or ethyl ether, methoxy, ethoxy or butoxytriglycol, 1-butoxyethoxy-2-propanol, 3-methyl-3-methoxybutanol, propyl-ene glycol tert-butyl ether and mixtures thereof. The amount of nonaqueous water-soluble solvent component, based on the total amount of the composition, is preferably up to 15 wt %, in particular 0.5 wt % to 10 wt %.

Another component of liquid laundry detergent compositions according to the invention that may be present, if desired, is a hydrotrope. Preferred hydrotropes comprise the sulfonated hydrotropes, for example, the alkylarylsulfonates or alkylarylsulfonic acids. The preferred hydrotropes are selected from xylene, toluene, cumene, naphthalene-sulfonate or -sulfonic acid and mixtures thereof. Counterions are preferably selected from sodium, calcium and ammonium. If necessary, the liquid laundry detergent compositions according to the invention may contain up to 20 wt % of a hydrotrope, in particular 0.05 wt % to 10 wt %.

Liquid laundry detergent compositions according to the invention may further comprise alkoxylated polyalkylenepolyamines which can be obtained by reacting alkylene oxides with polyalkylenepolyamines. Preferably, the liquid laundry detergent composition will comprise 0.1 to 10% by weight of alkoxylated polyalkylenepolyamines. In a preferred embodiment, the alkoxylated polyalkylenepolyamines are alkoxylated polyethyleneimines.

Polyethyleneimines are currently obtained by the homopolymerization of ethyleneimine. Ethyleneimine is a highly reactive, corrosive and toxic intermediate which can be synthesized in different ways (aziridines, Ulrich Steuerle, Robert Feuerhake; in Ullmann's Encyclopedia of Industrial Chemistry, 2006, Wiley-VCH, Weinheim). Alkoxylated polyalkylenepolyamines can be prepared as described in WO 2013/076024.

Detergent ingredients are common general knowledge. Detailed descriptions can be found, for example, in WO 99/06524 and WO 99/04313 and US 2008/0248987 and Liquid Detergents, Editor: Kuo-Yann Lai, Surfactant Sci. Ser., Vol. 67, Marcel Decker, New York, 1997, p. 272-304.

A further aspect of the present invention is the use of the modified polysaccharide of the present invention for increasing the whiteness of a washed fabric, the use of the modified polysaccharide of the present invention as anti-greying agent in aqueous laundry processes, the use of the modified polysaccharide of the present invention as a rheology modifier for homecare applications and the use of the modified polysaccharide of the present invention in the manufacture of a liquid laundry detergent composition.

Another aspect of the present invention is a method for increasing the whiteness of a washed fabric comprising the step of adding the modified polysaccharide of the present invention in an effective amount to a liquid laundry detergent composition and applying said composition in aqueous laundry processes. The present invention further relates to a method of reducing greying in aqueous laundry processes comprising adding the modified polysaccharide of the present invention in an effective amount to a liquid laundry detergent composition and applying said composition in aqueous laundry processes. The present invention further relates to a method of modifying the rheology of a homecare composition comprising adding the modified polysaccharide of the present invention in an effective amount to a homecare composition and applying said composition in a homecare application such as automatic dish wash or in an I&I (Institutional & Industrial) application. The present invention also relates to a method of manufacturing a liquid laundry detergent composition comprising mixing the modified xyloglucan of the present invention in an effective amount with components (B) and (C) as defined above and, optionally, further components are being mixed together in the presence of water. The order of addition of the various ingredients is not critical but it is preferred to add the detergent(s) first and to add the enzyme(s), if desired, as last component. Mixing can be accomplished, for example, by agitating or stirring. Said agitating or stirring can be performed until a clear solution or a homogeneous-looking dispersion has formed.

If solid detergent compositions are desired then the water can be removed, in whole or in part, for example by spray-drying, for example with the help of a spray nozzle.

The term “effective amount” means an amount of modified polysaccharide that is sufficient to increase the whiteness of a washed fabric, to reduce greying in aqueous laundry processes or to modify the rheology of a homecare composition.

### EXAMPLES

### Example 1

### Preparation of a Modified Polysaccharide as Shown in Table 1 as Polysaccharide 5

A four-necked 2 l glass vessel with stirrer and thermoelement/control was charged with 900 g water. At room temperature (20° C.) 14.7 l SO₂ (40 g) were passed for 50 minutes through a porous glass filter. 100 g Xyloglucan (DSP Gokyo Food & Chemical Co., Ltd. or Dainippon Sumitomo Pharma Co. Ltd, Osaka, CAS 39386-78-2) were added and with vigorous stirring the temperature was gradually heated to 80° C. (approx. 30 minutes) and the mixture was continuously stirred at 80° C. for additional 1.5 hours followed by a second dosage of 20 g of SO₂ that was passed at 80° C. (approx. 20 minutes). A final amount of 50 g of Xyloglucan were added and the total mixture was kept at 80° C. for another 2.5 hours. The dispersion was then quenched and neutralised with a 10% solution of caustic soda to obtain a final pH of 5.5-6.5.

The resulting solution is 15% showing a viscosity of 16,400 mPas. A dilution with water resulted in the 10%, 5% and 2% viscosities as shown in Table 1. Viscosity is determined at RT° C., via a Brookfield DV-II+due to DIN EN ISO 2555:2000-01 (LVT Spindle).

### Example 2

### Preparation of Modified Polysaccharides in General

In a 3 l necked vessel (with stirrer and cooler), 10 to 20 g gaseous SO₂ are dissolved in 425 g water at room temperature. 50 g of the polysacharide (see Table 1) are added (300-500 RPM, blade stirrer) and the temperature is raised to 80° C. and kept at that temperature for 90 minutes. Depending on the specific recipe (if the mass ratio polysaccharide(A)/SO₂ is <3.5:1; see Table 1), 10 to 20 g gaseous SO₂ are added, followed by an additional amount of 25 g of the polysaccharide if a 15% solution shall be prepared. The temperature is again kept at 80° C. for another 2 to 5 hours. The pH is set with 20% NaOH to pH 5.5(+/−0.25). Viscosity is determined at RT° C., via a Brookfield DV-II+due to DIN EN ISO 2555:2000-01 (LVT Spindle).

Table 1 shows the viscosity of 2%, 5%, 10% and 15% solutions. 2%, 5% and 10% solutions are obtained via dilution of 15% solutions with water.

TABLE 1
Viscosity of the different polysaccharides

| | | | Reaction | | | Viscosity | Viscosity |
|---|---|---|---|---|---|---|---|
| | | mass | time at | Viscosity | Viscosity | 10% | 15% |
| | | ratio | 80° C. | 2% solution | 5% solution | solution | solution |
| | Polysacharide | A/SO₂ | (hours) | (mPas) | (mPas) | (mPas) | (mPas) |
| 1 | Xyloglucan | 4.0 | 4 | 68 | 980 | 10,600 | — |
| 2 | Xyloglucan | 2.5 | 3 | 38 | 481 | 6,300 | — |
| 3 | Xyloglucan | 3.5 | 5 | 46 | 610 | 7,900 | — |
| 4 | Xyloglucan | 2.5 | 5 | 22 | 264 | 5,750 | 30,000 |
| 5 | Xyloglucan | 2.5 | 7 | 18 | 206 | 3,480 | 16,400 |
| 6 | Xyloglucan | 3.5 | 8 | 29 | 380 | 5,950 | 43,500 |
| 7 | Xyloglucan | 2.5 | 7.5 | 8 | 120 | 1,840 | 7,980 |
| 8 | Xyloglucan | 2.5 | 9 | — | 30 | 620 | 1,970 |
| 9 | Homoxylan | 2.5 | 5 | 12 | 127 | 1,620 | 8,950 |
| 10 | Glucomannan | 2.5 | 5 | 16 | 220 | 3,280 | 15,200 |
| 11 | Arabinoxylan | 2.5 | 5 | 20 | 245 | 4,650 | 22,650 |
| C1 | Homoxylan | — | — | 2,900 | — | — | — |
| C2 | Xyloglucan | — | — | 6,800 | — | — | — |

### Example 3

### Determination of the Anti-Greying Properties of the Modified Polysaccharides of the Present Invention

The grayness-inhibition action of the polysaccharides was tested by preparing wash solutions using water of 14° dH hardness (2.5 mmol/L; Ca:Mg:HCO₃ 4:1:8) containing 5 g/L of the test detergent T (see Table 2) and 1.0-1.5% of the modified polysaccharides of the present invention (see Table 1, 1 to 11) in comparison to 1.0-1.5% of the equivalent polysaccharides (see Table 1, C1 and C2) with respect to the detergent dosage.

TABLE 2
Detergent T

| Liquid Detergent Formulation | |
|---|---|
| Alkylbenzene sulfonic acid (C10-C13) | 5.7% |
| C13/15-Oxoalkohol reacted with 7 moles of | 5.4% |
| ethylene | |
| 1,2 Propylenglycol | 6% |
| Ethanol | 2% |
| Potassium coconut soap | 2.4% |
| KOH | 3.1 |
| Lauryl ether sulphate | 7.7% |
| Polysaccharide (unmodified or modified) | as stated |
| Water | to 100% |

The test fabrics were 10 cm×10 cm squares of different cotton (wfk10A as standard cotton, wfK12A as cotton terry cloth, wfk80A as cotton knit, EMPA 221 as cotton fabric, cretonne, bleached without optical brightener, T-shirt from Brantic, Kapart brand) and synthetic fabrics (wfk20A, wfk30A, EMPA406). The test was performed in a launder-O-meter (LP2 type from SQL Atlas, Inc.) with beakers of 1 L size. Soil was a mixture of two 2.5 g EMPA 101 (olive oil/carbon black on cotton, purchased at EMPA Testmaterials, St Gallen, Switzerland) and of two 2.5 g SBL 2004 fabrics (soil ballast fabric “Formula 2004” that simulates sebum grease stains, purchased from wfk Testgewebe GmbH, Bruggen, Germany).

The first cycle was run using the launder-O-meter beakers containing the test wash solution (0.25 L) plus test fabrics and ballast soil, at 40° C. for 20 min (fabric to liquor ratio of 1:10). After the wash, the test fabrics and ballast soil were separated. The process was repeated using the washed test fabrics and effectuating 3 cycles in total. New ballast soil was used for each cycle. After the 3 cycles, the test fabrics were rinsed in water, followed by drying at ambient room temperature overnight.

The greying of the cotton and synthetic test fabrics was measured by determining the degree of whiteness (reflectance values) after washing using a sphere reflectance spectrometer (SF 500 type from Datacolor, USA, wavelength range 360-700 nm, optical geometry) d/8° with a UV cutoff filter at 460 nm.

The anti-greying properties of the detergents tested were then quantified after addition of 1.0 to 1.5% of the respective polysaccharides (see Table 1). Reflectance values decrease with the visible greying of the fabrics, the higher the reflectance value, the better the anti-greying performance of the detergent. For simplicity, cotton delta reflectance values (ΔR) are represented in Table 3. Cotton ΔR values represent the difference between the reflectance after wash of the test detergent T containing the corresponding polysaccharide (R1) and the reflectance after wash of the test detergent without the polysaccharide for the summation of the 5 different cotton fabrics. An ΔR value >14 means a clearly visible contribution of the polysaccharide to the cotton anti-greying properties of the formulation T. Synthetic delta reflectance is not represented in Table 3, as the modified polysaccharides have no effect on the secondary-wash performance of synthetic fabrics.

For the determination of storage stability and compatibility in liquid detergent formulations, both modified polysaccharides of the present invention (see 1 to 11 in Table 3) and non-modified polysaccharides (see C1 and C2 in Table 3) were added to the detergent formulation and stored at 37° C. for 4 weeks. Important for a commercial liquid laundry detergent during storage is that the viscosity does not increase drastically (no gelling) and that the detergent has a slightly turbid to clear appearance with no signs of precipitation and/or phase separation. As shown in Table 3, insolubility is a major problem when non-modified polysaccharides (see C1 and C2 in Table 3) or when the modified cellulose (see C3 in Table 3, i.e. carboxymethylcellulose (CMC); CMC was directly dosed into the beakers) is used. In other words, precipitation (no clear solutions) was obtained with the comparative polysaccharides (see C1 to C3 in Table 3).

TABLE 3
Results from launder-O-meter washing tests and storage stability tests

| | | | Cotton, Delta | Cotton, Delta | Stability in |
|---|---|---|---|---|---|
| | | mass | Reflectance (%) | Reflectance (%) | liquid detergent |
| | | ratio | 1.0% by weight | 1.5% by weight | formulation (1% by |
| | Polysaccharide | A/SO2 | Polysaccharide | Polysaccharide | weight) |
| 1 | Xyloglucane | 4.0 | 22 | 29 | − |
| 2 | Xyloglucane | 2.5 | 32 | 36 | + |
| 3 | Xyloglucane | 3.5 | 30 | 33 | + |
| 4 | Xyloglucane | 2.5 | 30 | 35 | ++ |
| 5 | Xyloglucane | 2.5 | 28 | 32 | ++ |
| 6 | Xyloglucane | 3.5 | 31 | 33 | + |
| 7 | Xyloglucane | 2.5 | 28 | 31 | ++ |
| 8 | Xyloglucane | 2.5 | 24 | 28 | ++ |
| 9 | Homoxylane | 2.5 | 21 | 26 | ++ |
| 10 | Glucomannane | 2.5 | 15 | 22 | + |
| 11 | Arabinoxylane | 2.5 | 14 | 23 | + |
| C1 | Homoxylane | — | 12 | 20 | −− |
| C2 | Xyloglucane | — | 30 | 33 | −− |
| C3 | CMC** | — | 32 | 33 | −− |

pH of the liquid test detergents formulations was approx. 8.5.
Delta Reflectance cotton is represented as the average of a 2 times replication.
**CMC, Carboxymethylcellulose from Dow (Walocel CRT 2,000 PA)
++: clear/almost clear, soluble, no phase separation, no effect on viscosity
+: slightly turbid, soluble, no phase separation, no effect on viscosity
−: turbid, insoluble parts, slight increase on viscosity
−−: turbid, soluble, phase separation, strong increase of viscosity (gelation)

As shown in Table 3, the modified xyloglucane (1 to 8) have a positive effect on the secondary-washing action, preventing the re-deposition of the soil removed from the wash liquor to the fabrics. Also the modified polysaccharides 9 to 11 of Table 3 show similar performance as the comparative unmodified polysaccharides. Additionally, they all show good formulability when compared to the unmodified ones and CMC (C1 to C3).

In summary, the modified polysaccharides of the present invention perform as good as or outperform non-modified polysaccharides and CMC regarding the anti-greying properties. The results also show that the modified polysaccharides of the present invention outperform the non-modified polysaccharides and CMC in terms of solubility and formulation behavior (liquid formulations).

1.-12. (canceled)

13. A modified polysaccharide obtained by a process comprising treating a polysaccharide with gaseous or liquid SO₂.

14. The modified polysaccharide according to claim 13, wherein the polysaccharide is xyloglucan, mannan, xylan, starch or mixtures thereof.

15. The modified polysaccharide according to claim 13, wherein the process is carried out with a process-mass ratio of SO₂ to polysaccharide of from 0.1:1 to 5:1.

16. The modified polysaccharide according claim 13, wherein the modified polysaccharide shows a viscosity at 25° C. when dissolved at 2% in water of less than 100 mPas.

17. The modified polysaccharide according claim 13, wherein the process is carried out at a temperature in the range of from 0 to 150° C.

18. The modified polysaccharide according claim 13, wherein the process is carried out at a pressure in the range of from 0 to 10 bar.

19. A laundry detergent composition comprising the modified polysaccharide according to claim 13.

20. The laundry detergent composition according to claim 19, wherein said laundry detergent is liquid or gel-like.

21. A method for increasing the whiteness of a washed fabric comprising adding the modified polysaccharide according to claim 13 to a liquid laundry detergent composition and applying the composition in an aqueous laundry process.

22. A method for reducing greying in aqueous laundry processes comprising adding the modified polysaccharide according to claim 13 to a liquid laundry detergent composition and applying the composition in an aqueous laundry process.

23. A method for modifying the rheology of a homecare composition comprising adding the modified polysaccharide according to claim 13 to a homecare composition and applying the composition in a homecare application.

24. A method for manufacturing a liquid laundry detergent composition comprising mixing the modified polysaccharide according to claim 13 with at least one surfactant and at least one builder.
